(19) United States
(12) Patent Application Publication
(10) Pub. No.: US 2006/0153566 A1
(43) Pub. Date: Jul. 13, 2006

(54) Methods and apparatuses to provide a wavelength-division-multiplexing passive optical network with asymmetric data rates

(76) Inventors: Wayne V. Sorin, Mountain View, CA (US); Byoung Yoon Kim, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/035,663

(22) Filed: Jan. 13, 2005

(51) Int. Cl. H04J 14/00

(52) U.S. Cl. 398/72

(57) ABSTRACT

Various methods, systems, and apparatuses are described in which a wavelength-division-multiplexing passive-optical-network includes a wavelength-locked light source and a wavelength-specific light source. The wavelength-locked light source may be used for communications in a first direction in the wavelength division multiplexed passive optical network to supply data signals at a first data rate. The wavelength-specific light source may be used for communications in a second direction in the wavelength division multiplexed passive optical network to supply data at a second data rate.

### FIELD

Embodiments of this invention relate to wavelength-division-multiplexing passive-optical-networks. More particularly, an aspect of an embodiment of this invention relates to wavelength-division-multiplexing passive-optical-networks with asymmetric data rates.

### BACKGROUND

Some wavelength-division-multiplexing-passive-optical-networks typically dedicate each wavelength channel for a specific end user. Communications between that end user and the Central Office often occur at the same rate because the equipment generating the communication on both ends is similar.

### SUMMARY

Various methods, systems, and apparatuses are described in which a wavelength-division-multiplexing passive-optical-network includes a wavelength-locked light source and a wavelength-specific light source The wavelength-locked light source may be used for communications in a first direction in the wavelength division multiplexed passive optical network to supply data signals at a first data rate. The wavelength-specific light source may be used for communications in a second direction in the wavelength division multiplexed passive optical network to supply data at a second data rate.

Other features and advantages of the present invention will be apparent from the accompanying drawings and from the detailed description that follows below.

### BRIEF DESCRIPTION OF THE DRAWINGS

The present invention is illustrated by example and not limitation in the figures of the accompanying drawings, in which like references indicate similar elements and in which:

FIG. 1 illustrates a block diagram of an embodiment of a wavelength division multiplexed passive optical network with asymmetric data rates.

FIG. 2 illustrates a block diagram of an embodiment of a wavelength division multiplexed passive optical network using a single wavelength channel to provide data to multiple users.

### DETAILED DESCRIPTION

In general, various wavelength-division-multiplexing passive-optical-network are described. For an embodiment, the wavelength-division-multiplexing passive-optical-network includes a wavelength-locked light source and a wavelength-specific light source. The wavelength-locked light source may be used for communications in a first direction in the wavelength division multiplexed passive optical network to supply data signals at a first data rate. The wavelength-specific light source may be used for communications in a second direction in the wavelength division multiplexed passive optical network to supply data at a second data rate. The second data rate may be asymmetric compared to the first data rate. Further, the wavelength-division-multiplexing passive-optical-network may have an additional actively powered remote node that includes a router. The router multiplexes data on a single wavelength channel in the wavelength-division-multiplexing passive-optical-network to multiple end users' locations. The use of the router allows multiple users to be supported on a single wavelength channel in the wavelength-division-multiplexing passive-optical-network. Other features, aspects, and advantages of the present invention will be apparent from the accompanying drawings and from the detailed description that follows below.

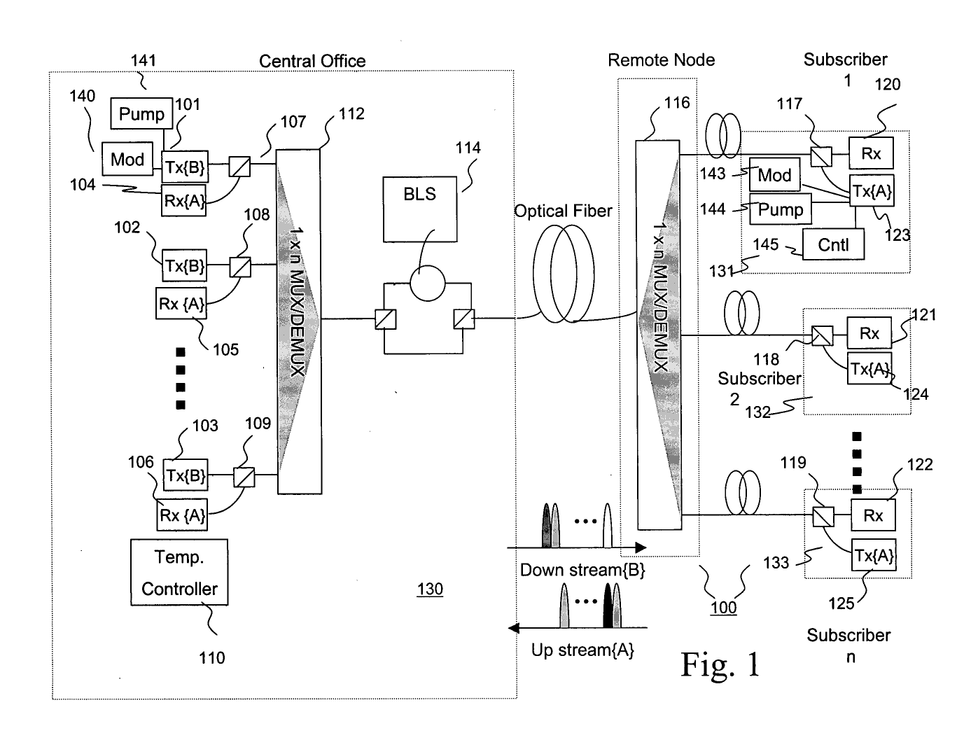

FIG. 1 illustrates a block diagram of an embodiment of a wavelength division multiplexed passive optical network with asymmetric data rates. The wavelength division multiplexed passive optical network (WDM PON) 100 may include a central office 130, a remote node, and a plurality of end user locations. The central office 130 may contain a plurality of wavelength-specific light sources 101-103, a plurality of optical receivers 104-106, a plurality of band splitting filters 107-109, a first 1×N multiplexer/demultiplexer 112, a first broadband light source 114, and a temperature controller 110. Each wavelength-specific light source 101-103 may be an optical transmitter such as a distributed feedback laser. Each wavelength-specific light source may have an associated modulator and gain pump. For example, the first wavelength-specific light source 101 has an associated first modulator 140 and first gain pump 141. The gain pump and modulator may each supply an electrical current to the active region of the light source.

Each end user location may contain an optical network unit (ONU) 131-133. Each ONU may include an optical receiver and a wavelength-locked light source with an associated modulator and gain pump. For example, the first subscriber's location may contain a first ONU 131 with a first optical receiver 120, a first wavelength-locked light source 123, such as a Fabry-Perot laser diode, a first band splitting filter 117, a first modulator 143, and a first gain pump 144. The first band splitting filter 117 is configured to direct wavelengths in a first wavelength band from a wavelength-specific light source in the central office to the first optical receiver 120. The first band splitting filter 117 is also configured to direct wavelengths in a different wavelength band from the broadband light source 114 into the first wavelength-locked light source 123.

The wavelength-specific light sources 101-103 in the central office may be used for downstream communications in the WDM PON to supply data to subscribers at a first data rate. The wavelength-locked light sources 123-125 in the subscribers' locations may transmit upstream communications in the WDM PON to supply data signals at a second data rate back to the optical receivers 104-106 in the central office 130. The first data rate may be asymmetric or in other words at a different bit rate compared to the second data rate. The first data rate for downstream communications, such as 1 gigabyte per second, may be greater than the second data rate for upstream communications, such as 100 megabytes per second.

The first pump 141 supplies a bias current to the first wavelength-specific light source 101. The bias current cooperates with a signal provided by the first data modulator 140 to generate the downstream data signal from the first wavelength-specific light source 101. Similarly, the second pump 144 supplies a bias current to the first wavelength-locked light source 123. The bias current cooperates with a signal provided by the second data modulator 143 to generate the upstream data signal from the first wavelength-locked light source 123.

The second 1×N multiplexer/demultiplexer 116 in the remote node may be used for both 1) routing the wavelengths between the subscribers' locations and the central office as well as 2) supplying a separate spectral slice of a broadband light signal 114 to wavelength lock an output wavelength of each wavelength-locked light source 123-125.

The broadband light source 114 supply an optical signal containing a first band of wavelengths, such as the C-band (1530 nm ˜1560 nm), to the second 1×N multiplexer/demultiplexer 116.

The second 1×N multiplexer/demultiplexer 116 in the remote node spectrally slices this broadband light signal from the broadband light source 114. A first port of the second 1×N multiplexer/demultiplexer 116 couples via an optical cable to the first ONU 131. The second 1×N multiplexer/demultiplexer 116 wavelength locks the output wavelength of the first wavelength-locked light source 123 by injecting a first spectral slice into the first wavelength-locked light source 123. The first wavelength-locked light source 123 is operated below the lasing threshold when being suppressed by the first injected spectral slice. The first wavelength-locked light source 123 locks its output wavelength to approximately the wavelength of the injected spectral slice. Each port of the second 1×N multiplexer/demultiplexer 116 generates a spectral slice of the broadband light signal with a different wavelength within the wavelength range of the broadband light signal.

Each optical receiver 120-123 in the subscribers' locations is configured, via its band splitting filters 117-119, to receive a wavelength signal corresponding to the associated wavelength-specific light source 101-103 in the central office 130. Each optical receiver 104-106 in the central office 130 is configured, via its band splitting filters 107-109, to receive a wavelength signal corresponding to the associated wavelength-locked light source 123-125 in a subscriber's location.

The wavelength-locked light source may be a Fabry-Perot laser diode, a Reflective Semiconductor Optical Amplifier (RSOA), or other similar optical transmitter configured to operate below a lasing threshold when being suppressed by an injected spectral light signal. The wavelength-specific light source may be a Distributed FeedBack (DFB) laser, DBR laser (Distributed Bragg Reflector) laser, tunable external cavity laser or similar optical transmitter configured to transmit a repeatable specific wavelength with enough power to transmit at a high data speed.

A temperature controller, such as the first temperature controller 145, may alter the operating temperature of the wavelength-locked light source to fine tune its resonant wavelength. Similarly, a temperature controller, such as the second temperature controller 110, may alter the operating temperature of the wavelength-specific light source to fine tune its resonant wavelength.

The modulator may be a direct modulator or an external modulator. The direct modulator may cooperate with a gain pump to directly data modulate the first wavelength-specific light source. The direct modulation alters a gain of its associated wavelength-specific light source or wavelength-locked light source. The external modulator, such as LiNb03 (Lithium Niobate) or EA (electro-absorption) modulators, data modulates its associated wavelength-specific light source or wavelength-locked light source. The external modulator modulates by passing or blocking the light generated from the light source in a separate stage from where the lasing action occurs in the light source. The gain pump may also control the bias current supplied to its associated optical transmitter to alter the resonant wavelength of its optical transmitter.

For some applications, such as Fiber To The Curb (FTTC) high data rates in at least one direction are desired. At data rates around 1 Gigabits per second (Gbps) it may become difficult to directly modulate a wavelength-locked light source at the high speeds due to the response time of the non-lasing wavelength-locked light source. However, the hybrid WDM-PON with both high power, high speed, wavelength-specific light sources as well as low cost, low power, wavelength-locked light sources can be used to achieve a cost effective asymmetric communication system. High speed wavelength-specific light sources can be used to send higher speed data in one direction. Wavelength-locked light sources can be used for data transfer in the reverse direction at a slower speed. The ratio between the high speed data rates, such as 10 Gbps, and the slower speed data rates, such as 155 Mbps, can be greater than fifty to one.

The hybrid WDM-PON retains the advantage of having identically manufactured ONUs with low cost transmitters in the field (i.e. installed in subscriber's locations). The consumable ONUs makes them easier for maintenance, service and repair. The wavelength-specific light sources are located in the central office where maintenance is easier and there is less chance of confusing which wavelength-specific light source is connected to each port of the first 1×N multiplexer/demultiplexer.

In an embodiment, the wavelength-specific light sources at the central office can be directly modulated DFB lasers. For an example 16 wavelength system, the hybrid WDM PON can use 16 different DFB lasers separated by 200 GHz (or 1.6 nanometers (nm) in wavelength). The total range of the down stream bandwidth is approximately 26 nm, i.e. 16 channels×1.6 nm/channel. Each DFB laser can be stabilized or locked to the appropriate channel by using a thermo-electric coder (TEC) to temperature control the DFB chip temperature. Since the wavelength/temperature sensitivity for a DFB laser may be 0.1 nm/degree Centigrade (° C.), temperature stability merely should be maintained within a few degrees since the channel spacing is 1.6 nm. The example DFB lasers can be directly modulated at 1.25 Gbps to transfer a gigabit Ethernet downstream data signal. Higher and lower data rates can also be used.

The downstream wavelength band for the optical transmitters in the central office may be in a first wavelength band such as the L-band (1570 nm˜1600 nm), O-band (˜1310 nm), S-band (1450 nm), etc. The upstream wavelength band for the optical transmitters in the end user's locations may be in a second wavelength band, such as the C-band, different then the first wavelength band. Accordingly, the broadband light source, such as an Erbium Doped Fiber Amplifier source, may generate a broadband light signal encompassing the C-band. The second 1×N multiplexer/demultiplexer then spectrally slices up in the incoming C-band light signal to send each end user location its own discrete wavelength.

Various devices may be used to fine tune the resonant wavelength of the optical transmitters in the central office and end user locations such as the above mentioned temperature controllers, MEMS (Micro Electro-Mechanical Structures), dielectric optical band pass filters for feedback, Fiber Bragg Gratings (FBG) using strain tuning and other techniques.

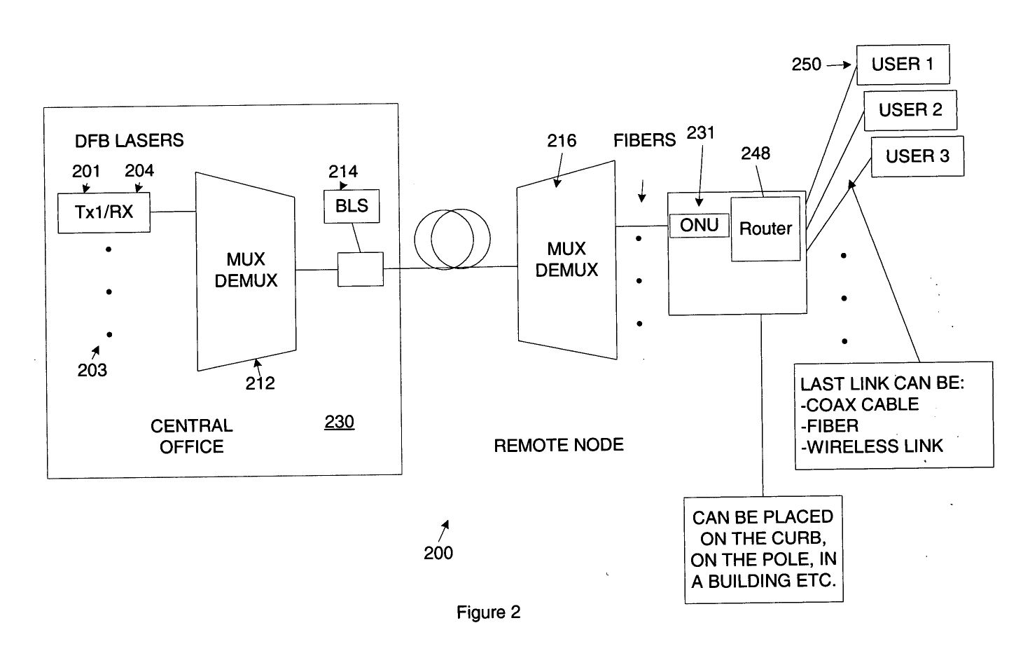

FIG. 2 illustrates a block diagram of an embodiment of a wavelength division multiplexed passive optical network using a single wavelength channel to provide data to multiple users. The hybrid WDM PON 200 may include central office 230, a non-powered remote node with a first multiplexer/demultiplexer 216, an actively powered remote node including a first ONU 231 and a first router 248, and a plurality of end user locations, such as a first end user location 250. The hybrid WDM PON 200 may have one or more passive non-powered remote nodes between the central office and the ONU units in the actively powered node. The ONU units cooperate with a router 248 in the actively powered node to supply data to multiple end users sharing a single wavelength channel. The router 248 multiplexes the data on the single wavelength channel to the multiple end user locations.

A first wavelength-specific light source 201 in the central office 230 supplies a high speed and high power data signal on a single wavelength channel in the WDM PON 200. The router 248 is disposed between the first wavelength-locked light source 201 and the multiple end user locations. The data transmitted on each wavelength channel may be a combination of data coming from or going to more than one end user. The data on the single wavelength channel is multiplexed to supply different segments of the data to each of the multiple end user locations. Thus, each wavelength channel in the WDM PON can be used to supply data to and receive data from multiple end users. The second actively powered remote node allows the addition of another distribution system so that the multiple users may merely use a single wavelength channel. This additional distribution system may be used to share the data rate capability of the hybrid WDM-PON system with more users thereby reducing the cost per user.

The router 248 may be a time division multiplexed switch, an Ethernet packet switch, Digital Subscriber Line Access Multiplexer (DSLAM), or other similar routing device. In an embodiment, the link between the ONU 231 in the active remote node and the end users can be an optical fiber (either single-mode or multi-mode), a coax cable, a UTP cable (Unshielded Twisted Pair), a RF wireless link or some other link. One of the functions of the router 248 may be to convert optical signals into a different transmission form, such as digital signals, analog signals, wireless signals, IP-type packets, etc.

As discussed, the router 248 may be a time division multiplexed switch. The time division multiplexed switch multiplexes by different time segments the data on the single channel to multiple end user locations. A modulator in the central office may data modulate the first wavelength-specific light source 201 at N times the rate at which the router 248 is communicating with each individual end user. N may be equal to the number of end users coupled to that router. Thus, a single high speed, high power data signal may be sent across a single wavelength channel in the WDM PON 200 to supply data to multiple end users in a close proximate geographic location.

The router 248 may also be an Ethernet packet switch. The Ethernet packet switch uses a networking packet technology that can break up a high data rate optical signal into many individual packets for transmission to multiple end users. The packets include a header section for addressing etc. and a payload section to carry data. Each packet in a packet-switched network contains a destination address. Thus, all packets in a single wavelength channel do not have to travel the same path. They can be dynamically routed over an Ethernet-type network associated with the router. The destination computing device in the end user's location reassembles the packets back into their proper sequence.

The router 248 may also be a DSLAM. The DSLAM converts electronic digital signals into optical signals and vise versa. Moreover, the DSLAM separates incoming traffic and directs the traffic onto the appropriate line going to an end user's location.

The actively powered node may be located physically close to the end user's location such as at a neighborhood pole, a curb unit, a distribution box in an apartment building, etc. Thus, the router 248 and the ONU for a single wavelength channel that supports multiple users may be located on a curb, pole, etc. near the multiple end users' locations. Thus, the router 248 is located physically nearer to the multiple end users' locations as compared to the physical distance between the multiple end users' locations and a central office.

The hybrid WDM PON 200 may support multiple end users on a single wavelength channel which implements asymmetric data rates between the upstream and downstream communications. Accordingly, a first wavelength-locked light source in the first ONU 231 cooperates with the router 248 to supply data signals at a first data rate in an upstream direction in the WDM PON. A first wavelength-specific light source 201 in the central office 230 supplies data signals at a second data rate in a downstream direction in the WDM PON. The second data rate is asymmetric compared to the first data rate. The second data rate being high speed and high powered may be greater than the first data rate.

The hybrid WDM PON 200 using a single wavelength channel to provide data to multiple users may also be implemented with similar optical transmitters, such as wavelength-locked light sources, in both the central office and the remote nodes.

Note, the specific numeric reference should not be interpreted as a literal sequential order but rather interpreted that the first band of wavelength is different than a second band of wavelengths. Thus, the specific details set forth are merely exemplary.

In the forgoing specification, the invention has been described with reference to specific exemplary embodiments thereof. It will, however, be evident that various modifications and changes may be made thereto without departing from the broader spirit and scope of the invention as set fourth in the appended claims. The specification and drawings are, accordingly, to be regarded in an illustration rather then a restrictive sense.

We claim:

1. An apparatus, comprising:
a wavelength-locked light source for communications in a first direction in a wavelength division multiplexed passive optical network (WDM PON) to supply data signals at a first data rate; and
a wavelength-specific light source for communications in a second direction in the WDM PON to supply data at a second data rate.

2. The apparatus of claim 1, wherein the second data rate is asymmetric compared to the first data rate.

3. The apparatus of claim 1, wherein the wavelength-locked light source is a Fabry-Perot laser diode configured to operate to operate below a lasing threshold when being suppressed by an injected light signal.

4. The apparatus of claim 3, further comprising:
a broadband light source to supply an optical signal containing a first band of wavelengths to a multiplexer/demultiplexer, wherein the Fabry-Perot laser diode to couple to a port of the multiplexer/demultiplexer to receive a spectral slice of the optical signal from the broadband light source to lock an output wavelength of the Fabry-Perot laser diode to a wavelength of the spectral slice.

5. The apparatus of claim 1, wherein the wavelength-locked light source is a reflective semiconductor optical amplifier configured to operate below a lasing threshold when being suppressed by an injected light signal.

6. The apparatus of claim 1, wherein the wavelength-specific light source is a Distributed FeedBack laser.

7. The apparatus of claim 1, further comprising:
a direct modulator to directly data modulate the wavelength-specific light source.

8. The apparatus of claim 1, further comprising:
an external modulator to data modulate the wavelength-specific light source.

9. The apparatus of claim 2, wherein the second data rate is greater than the first data rate.

10. A method, comprising:
supplying data signals at a first data rate in a first direction in a wavelength division multiplexed passive optical network (WDM PON); and
supplying data signals at a second data rate in second direction in the WDM PON, wherein the second data rate is asymmetric compared to the first data rate.

11. The method of claim 10, further comprising:
generating the data signals at the second rate with a wavelength-specific light source and directly modulating the light from the wavelength-specific light source where the lasing action occurs in the wavelength-specific light source.

12. The method of claim 10, further comprising:
generating the data signals at the first rate with a wavelength-locked light source.

13. The method of claim 12, further comprising:
spectrally slicing a broadband light signal with a multiplexer/demultiplexer;
wavelength locking an output wavelength of the wavelength-locked light source by injecting a first spectral slice into the wavelength-locked light source; and
operating the wavelength-locked light source below the lasing threshold when being suppressed by the first injected spectral slice.

14. The method of claim 10, further comprising:
multiplexing data from two or more end users on a single wavelength channel in the WDM PON.

15. An apparatus, comprising:
means for supplying data signals at a first data rate in a first direction in a wavelength division multiplexed passive optical network (WDM PON); and
means for supplying data signals at a second data rate in second direction in the WDM PON, wherein the second data rate is asymmetric compared to the first data rate.

16. The apparatus of claim 15, further comprising:
a light source to generate the data signals at the second rate; and
means for directly modulating light from the light source in a stage where lasing action occurs in the light source.

17. The apparatus of claim 16, further comprising:
means for generating the data signals at the first rate with a type of light source different than the light source generating the data signals at the second rate.

18. The apparatus of claim 15, further comprising:
means for multiplexing data from two or more end users on a single wavelength channel in the WDM PON.

19. An apparatus, comprising:
a wavelength-specific light source to supply data on a single wavelength channel in a wavelength division multiplexed passive optical network (WDM PON) to multiple end user locations; and
a router disposed between the wavelength-specific light source and the multiple end user locations, wherein the router multiplexes data on the single wavelength channel to the multiple end user locations.

20. The apparatus of claim 19, wherein the router is a time division multiplexed switch.

21. The apparatus of claim 19, further comprising:
a wavelength division multiplexer/demultiplexer in a first remote node coupled to the router in a second remote node.

22. The apparatus of claim 19, wherein the router is located physically nearer to the multiple end users' locations as compared to the physical distance between the multiple end users' locations and a central office.

23. The apparatus of claim 19, wherein the router and a first wavelength-locked light source are part of an actively powered node.

24. The apparatus of claim 19, wherein a first wavelength-locked light source cooperates with the router to supply data signals at a first data rate in the WDM PON, and the wavelength-specific light source supplies data signals at a second data rate asymmetric compared to the first data rate.

25. The apparatus of claim 19, wherein a twisted pair of wires couples signals between a first end user location and the router.

26. The apparatus of claim 19, wherein a wireless connection couples signals between a first end user location and the router.

27. A system, comprising:
a wavelength division multiplexed passive optical network (WDM PON) that includes
a wavelength-locked light source for communications in a first direction in a wavelength division multiplexed passive optical network (WDM PON) to supply data signals at a first data rate, and
a wavelength-specific light source for communications in a second direction in the WDM PON to supply data at a second data rate, wherein the second data rate is asymmetric compared to the first data rate.

28. The system of claim 27, further comprising:
a wavelength division multiplexer/demultiplexer in a first remote node coupled to a router in a second remote node, wherein the router multiplexes data on the single wavelength channel to multiple end user locations.
